(19) United States
(12) Patent Application Publication
(10) Pub. No.: US 2010/0128804 A1
(43) Pub. Date: May 27, 2010

(54) Automatic Phase Shifter and Aligner for High-Speed Serial Data

(76) Inventor: JOSEPH SHIRAN, Palo Alto, CA (US)

Correspondence Address: IPxLAW Group LLP, 95 South Market Street, Suite 570, San Jose, CA, 95113, US

(21) Appl. No.: 12/543,500

(22) Filed: Aug. 18, 2009

Related U.S. Application Data
(60) Provisional application No. 61/089,655, filed on Aug. 18, 2008.

(51) Int. Cl. H04L 27/00

(52) U.S. Cl. 375/259

(57) ABSTRACT

Automatic Phase Shifter and Aligner for High-Speed Serial Data including a serializer device per data stream, a single phase detector per pair of data streams to measure the phase offset between the pair of data streams, a circuit that generates an offset signal proportional to the phase offset that is used to adjust the phase of the reference clock of the serializer for one of the parallel data streams such that its phase is bit-aligned with the second data stream, and a bit shifter per each 30 parallel data stream that aligns the two data streams within one bit.

### PRIORITY CLAIM

This patent document claims the benefit of U.S. Provisional Application No. 61/089,655 entitled “Automatic Phase Shifter and Aligner for High-Speed Serial Data” and filed on Aug. 18, 2008, which is incorporated herein by reference in its entirety.

### BACKGROUND

This document relates to data communication apparatus, techniques and systems.

Various data communication apparatus and systems handle two or more parallel data streams that have certain temporal or phase relations with respect to one another. It is desirable to maintain such relative temporal or phase relations in various data communication operations.

In particular, the bandwidth of high-speed optical transmission systems can be increased by employing Differential Quadrature Phase-Shift Keying as a modulation format. Compared to the Non-Return to Zero (NRZ) modulation format used in lower-bandwidth systems with one symbol per bit, DQPSK has two symbols per bit. See, for example, U.S. Pat. No. 7,327,961.

### SUMMARY

Techniques, devices and applications are provided based on a data communication circuit to align the phase of two or more parallel data streams. In one aspect, a circuit can include a serializer device per data stream, a single phase detector per pair of data streams to measure the phase offset between the pair of data streams, a circuit that generates an offset signal proportional to the phase offset that is used to adjust the phase of the reference clock of the serializer for one of the parallel data streams such that its phase is bit-aligned with the second data stream, and a bit shifter per each 30 parallel data stream that aligns the two data streams within one bit. This and other aspects are described in greater detail in the drawings, the description and the claims.

### BRIEF DESCRIPTION OF DRAWINGS

FIG. 1 shows an implementation example of the present automatic phase shifter and aligner.

FIG. 2 shows an exemplary circuit following that shown in FIG. 1.

### DETAILED DESCRIPTION

In various optical transmission systems, circuit elements in the transmission paths of parallel data streams may cause different delays in different data streams due to various factors such as spatial temperature variations, temporal temperature variations and aging of such circuit elements. Circuitry mechanisms for detecting and correcting errors in relative phase shifts between different parallel data streams can be implemented to adjust the relative timing or phase between different parallel data streams.

This document provides an exemplary implementation of an automatic phase shifter and aligner to dynamically align the relative timing or phase of two or more parallel data streams. One of applications of the present automatic phase shifter and aligner is to provide an alignment circuitry in data communication devices and modules with parallel data streams.

For example, in certain modulation schemes that require at least two bits per symbol, it is necessary to synchronize and align the two data streams to each other, for other schemes more than two streams have to be aligned. The present of the present automatic phase shifter and aligner can be used to resolve the dynamic alignment of the phase of two or more data streams (example is for two streams), to maintain a fixed alignment during different conditions of temperature and aging.

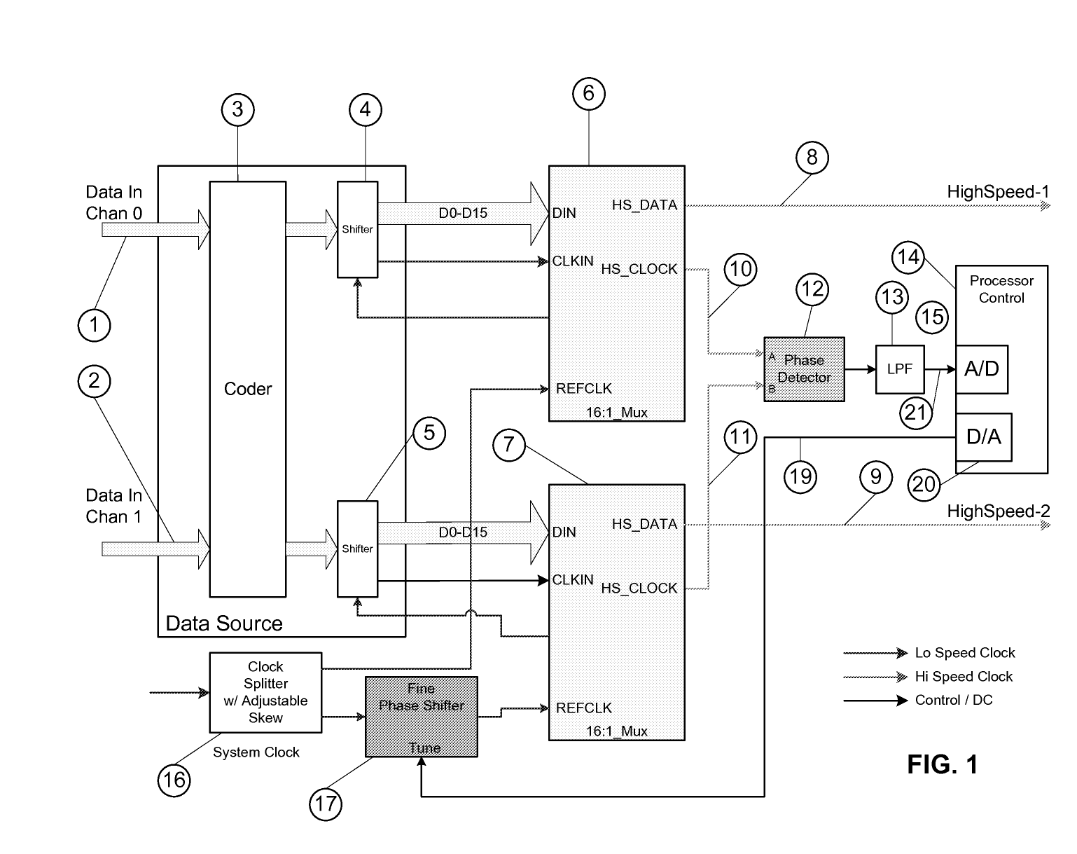

FIG. 1 shows an exemplary implementation of an automatic phase shifter and aligner. This design includes a data source that has a coder [3] to receive to data input channels [2] and two phase shifters [4][5] at the output side of the coder [3]. Two serializer circuits [6][7] are connected downstream from the two phase shifters [4][5] to receive the two data channels from the two phase shifters [4][5]. A phase detector [12] with two input ports A and B is provided to receive the two data channels from the two serializers

[7]. A low-pass filter LPF [13] and a processor [14] are provided to process the output of the phase detector [12].

The data input to the circuit in FIG. 1 includes two separate streams [1,2] that are labeled as channel 0 and channel 1 and are locked to the same clock. Both channels are sent through a coder [3] that is pre-coding the data, in some cases for a specific modulation, such as DQPSK pre-coder. The precoder function can be done in a commercially available field programmable gate array (FPGA). Both channels go through bit shifters [4, 5], respectively. Each bit shifter can adjust 0 to N bit shifts in the data stream to compensate for complete high speed clock period phase shift. The bit shifter can be initialized with ‘0’ shift and can be changed as needed by measurements when the system is aligned. In one implementation, this function can be incorporated into the same FPGA that is used for pre-coding the data.

Data out of the phase shifters [4][5] are sent to two separate 16:1 serializers [6,7] that latch and shift the data into two high-speed streams that are 16 times the incoming data bus rate. The Serdes [6,7] can be “FIFO less” to avoid any unknown delays through the device. This type of Serdes is commercially available and can be implemented in various configuration. For example, the Vitesse 1237 device can be used for this purpose. Furthermore, other types of serializers, such as 10:1 serializers can be used as long they do not have FIFOs.

The two streams out of the 16:1 multiplexer that generates the data are sent to the next stage as HighSpeed-1 and HighSpeed-2 lines [8,9]. The multiplexers also generate a clock that is responsible of clocking the HighSpeed data. This clock has the same frequency as the HighSpeed data, and a fixed skew to the HighSpeed data. This skew can change slightly due to temperature changes, and its change can be accurately characterized.

The phase between the two high speed data lines (HighSpeed-1 and HighSpeed-2) can be measured to provide an accurate indication of the phase alignment between the two HighSpeed Clocks [10, 11]. Both High Speed clocks are sent into a phase detector [12] that provides a pulse width relative to the phase shift between the two clocks. The pulses go through a low pass filter [13] to generate a voltage [21] that represents the phase shift. The Processor control circuit [14] converts this voltage using an analog to digital (A/D) [15] circuit to a digital value.

The System clock goes through a splitting clock generator [16] that allows setting of the relative phase on each one of its outputs. One of the clocks driving the 16:1 multiplexers goes through a fine phase shifter circuit [17] that has an analog tune input to accurately control the clock shift. Fine shifting can be within one bit resolution. An example of a commercially available phase shifter is the GigOptix iT4036 device. Note that a second phase shifter may have to be inserted in the second data stream to compensate for the inherent delay of the phase shifter.

The Processor [14] generates analog value [19] out of a D/A [20] circuit that drives the Tune input on the fine phase shifter [17]. The phase alignment is to keep the two HighSpeed data lines [8,9] perfectly aligned. Receiving equipment (built in or external) is used with to monitor the two HighSpeed data lines [8,9] to verify the alignment while the Coder [3] is sending a special training sequence that can be recognized and distinguish between the bit phases of the two streams.

The first is the coarse alignment where the two signals are aligned to the best resolution that is allowed by the clock distribution circuit [16]. This alignment can be set one time and will be calculated based on the physical delays in the system, and settings of the fine shifter in its middle range. The phase is verified by using the training sequence that is received and interpreted in the receiver. If the two streams [8,9] differ in more than one bit, then the bit shifter [4,5] of one of the streams is incremented to compensate the shift. The fine phase shifter [17] will be adjusted to compensate for small dynamic changes in operating conditions (such as voltage, temperature, and aging). Last, the accurate voltage of the phase detector [21] will be recorded for calibration purposes.

Temperature compensation can be provided. The behavior of the phase shift in different temperatures can be characterized, and then entered to the calibration formula to allow the circuit to be automatically adjusted based on measured temperature. In implementations, the whole circuit of clock driving and phase alignment can be integrated into a single chip that will allow accurate control of the phase of two circuits at all times.

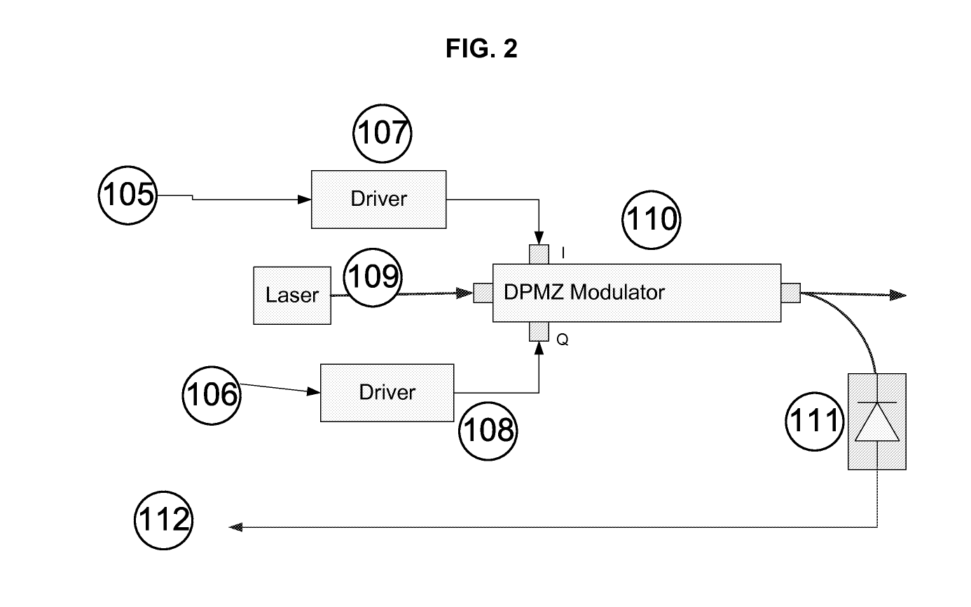

FIG. 2 shows an exemplary circuit following that shown in FIG. 1. The two high speed data lines [8 and 9 in FIG. 1] are input to two high-speed amplifier drivers [107, 108]. The drivers are used to drive the two arms of an optoelectronic modulator that modulates the light from a laser [109]. An example of such a modulator is the JDSU Dual Parallel Mach-Zehnder (DPMZ) modulator used for optical DQPSK transmission. A tap photodiode [111] at the output of the modulator is used to monitor the output signal [112] that is directed to microcontroller. For the modulator shown in FIG. 2, the circuit in FIG. 1 is used to phase align the two data streams [105, 106].

Only one exemplary implementation of the present automatic phase shifter and aligner is described. This implementation is an example of a data communication circuit to align the phase of parallel data streams. Such circuit can include a serializer device per data stream, a single phase detector per pair of data streams to measure the phase offset between the pair of data streams, a circuit that generates an offset signal proportional to the phase offset that is used to adjust the phase of the reference clock of the serializer for one of the parallel data streams such that its phase is bit-aligned with the second data stream, and a bit shifter per each parallel data stream that aligns the two data streams within one bit. The circuit can be used for transmitting data with a modulation scheme that has two or more bits per symbol. The circuit can also be used for transmitting data with optical DQPSK modulation.

Variations, modifications and enhancements of the described implementation, and other implementations can be made based on what is described and illustrated in this document.

What is claimed is what is described and illustrated, including:

1. A data communication circuit to align the phase of two or more parallel data streams, comprising:
a first serializer device that receives parallel data streams, respectively;
a single phase detector per pair of data streams to measure the phase offset between the data streams;
a mechanism for generating an offset signal proportional to the phase offset that is used to adjust the phase of the reference clock of the serializer for one of the parallel data streams such that its phase is bit-aligned with the second data stream; and
a bit shifter per each parallel data stream that aligns the two data streams within one bit.

2. A method for data communication, comprising operating a circuit of claim 1 to transmit data with a modulation scheme that has two or more bits per symbol.

3. A method for data communication, comprising operating a circuit of claim 1 to transmit data with an optical DQPSK modulation.
